(19) United States
(12) Patent Application Publication
(10) Pub. No.: US 2008/0064813 A1
(43) Pub. Date: Mar. 13, 2008

(54) METHOD FOR PRODUCING CROSSLINKABLE ORGANOPOLYSILOXANE DISPERSIONS

(75) Inventor: Otto Schneider, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: Wacker Chemie AG, Munich (DE)

(21) Appl. No.: 11/937,557

(22) Filed: Nov. 9, 2007

Related U.S. Application Data
(63) Continuation-in-part of application No. PCT/EP2006/004201, filed on May 4, 2006.

(30) Foreign Application Priority Data
May 12, 2005 (DE) 10 2005 022 099.1

(51) Int. Cl. C08G 77/06

(52) U.S. Cl. 524/837

(57) ABSTRACT

Dispersions of crosslinked organopolysiloxanes are prepared by reacting an alkoxy- or hydroxy-functional organopolysiloxane, in a dispersion medium, with an alkoxysilane bearing at least one further group which increases the reactivity of the silane alkoxy groups such that the viscosity at least doubles within a period of 2 hours.

### CROSS-REFERENCE TO RELATED APPLICATIONS

This application is a continuation-in-part of PCT Application No. PCT/EP2006/004201 filed 4 May 2006 which, in turn, claims the priority to German Application No. DE 10 2005 022 099.1, filed 12 May 2005.

### BACKGROUND OF THE INVENTION

1. Field of the Invention

The invention relates to a process for preparing dispersions of crosslinked organopolysiloxanes, and dispersions of crosslinked organopolysiloxanes preparable thereby. The invention additionally relates to shaped bodies produced from the dispersions.

2. Background Art

For the preparation of polysiloxanes with high viscosity there exists a variety of methods. U.S. Pat. No. 5,942,574 discloses the preparation of emulsions from starting materials with a high viscosity of up to 10,000,000 mPa·s. For that purpose it is necessary, however, to have specially constructed, heavy extruders. The resultant emulsions are very coarse and of low stability. These emulsions contain silicones which, though highly viscous, are not crosslinked.

Emulsions of crosslinked silicones are likewise known. For the crosslinking of the silicones there is a need for crosslinkers and also catalysts which contain (heavy) metal or are metal-free. In some cases, inhibitors are used as well, for the purpose of controlling the reactivity and pot life, in order to prevent unwanted premature gelling.

According to U.S. Pat. No. 5,001,187, an OH-terminal polydimethylsiloxane is polymerized in emulsion under acidic conditions, and following addition of tin catalyst and evaporation to remove water, an elastomer film is formed over the course of 7 days.

US 2001/0027233 A1 describes a similar preparation of an elastomer from a two-component system. One emulsion comprises an OH-terminal polydimethylsiloxane and the crosslinker in emulsified form. The second emulsion comprises the tin catalyst. After the two emulsions have been mixed, the components react under tin catalysis. This forms a suspension having crosslinked particles of relatively low size and enhanced dispersability in resins.

Us 4,894,412 describes a self-crosslinking aminosiloxane emulsion which is prepared at 70° C. in a three-day, base-catalyzed reaction encompassing a plurality of process steps and using seven components. After the water has evaporated, a flexible, rubberlike film is obtained.

EP 0 874 017 B1 claims chain extension reactions under metal catalysis. The silicones obtained are oils having viscosities of up to 75,000,000 mm²/sec, that are neither hard nor are elastomeric films or powders.

DE 2912431 A1 describes the preparation of organopolysiloxane latex starting from cyclic siloxanes which are ring-opened and polymerized using strongly acidic emulsifiers as catalysts, such as dodecylbenzenesulfonic acid, for example, in the presence of a functional trialkoxysilane that has the functional group in the γ-position. For this purpose the emulsion is heated at 80° C. for at least 2 hours, and thereafter must be aged at a lower temperature, after which it is neutralized.

WO 2004/069899 describes the preparation of aqueous silicone oil emulsions which contain small amounts of octamethylcyclotetrasiloxane (D4) and therefore find use in the cosmetics sector, by reaction of emulsions of silanol-functional polysiloxanes with γ-aminosilanes, such as 3-aminopropyltrimethoxysilane or 3-(2-aminoethylamino)propyltrimethoxysilane, in the presence of NaOH as catalyst. The reaction time amounts to 6 to 8 hours at room temperature, during which the viscosity of the silicone polymer increases from 4000 to 6500 mPas. In spite of the use of trifunctional silane no crosslinked elastomer is obtained.

Water-based RTV-1 [one-component, room temperature-crosslinking] mixtures likewise have metal-containing catalysts added to them in order to impart high reactivity, rapid filming, etc., as described for example in U.S. Pat. No. 5,861,459. In order to obtain further desirable properties of the elastomer film, such as adhesion, a multiplicity of additives are required, such as amino-functional organopolysiloxanes or special silicone resins, which must themselves be prepared, which is costly and inconvenient.

Metal-free aqueous RTV-1 dispersions are composed, as set out in EP 828 794 B1, of at least the following 3 components:

1. organopolysiloxanes containing condensable groups;

2. (amine-free) organosilicon compounds which function as crosslinkers and have at least 3 crosslinkable groups;

3. basic, N-containing organosilicon compounds, in addition to emulsifier(s) and water to form the dispersion.

EP 655 475 B1 identifies specific silicone resins as crosslinker molecules.

This review shows that the composition or preparation of silicone emulsions which dry to form a hard or elastomeric silicone network is unsatisfactory. The emulsions of crosslinkable silicones are complex in terms of formula and preparation processes, and are composed typically of a plurality of required components. As a result of the varying properties of the individual components and also of their influences on one another in the emulsion during preparation, it is difficult to achieve consistent quality of the crosslinked silicone in the emulsion. Furthermore, catalysts, especially metal-containing catalysts, and solvents, are unwanted because of their toxicological, environmentally adverse or other unfavorable properties, such as impairment of the emulsion's stability on storage.

DE-A 2500020 describes a process for preparing aminosiloxanes wherein silanol-terminated polysiloxanes are reacted with α-aminomonoalkoxysilanes. The reaction proceeds at moderate temperatures with elimination of alcohol, polysiloxane oils having terminal amino groups being produced. DE-A 1244181 likewise describes a process for preparing terminally aminomethyl-substituted organopolysiloxanes, in which bromomethyl-substituted monoalkoxysilane is reacted with secondary amines, the intermediate formed being an α-aminomonoalkoxysilane which is hydrolyzed together with alkyldihalosilane or alkyldialkoxysilane to give the terminally aminomethyl-substituted organopolysiloxane. In these two processes, no crosslinked organopolysiloxanes are obtained.

### SUMMARY OF THE INVENTION

An object of the invention was to provide dispersions of crosslinked hard or elastomeric organopolysiloxanes, and also a simple and reliably implementable process for preparing these dispersions, with which the aforementioned disadvantages are avoided. Furthermore, these dispersions desirably form, on evaporation of water, hard or elastomeric films or powders which have effective adhesion to different substrates. The process preferably does not include any chemical reaction step requiring separate implementation, in particular no reaction which requires heating, and preferably requires but few starting materials. A further object was to provide dispersions of crosslinked organopolysiloxanes that are low in particle size, stable, and preferably pH-neutral (pH range approximately 5-8). A yet further object was to provide dispersions of crosslinked organopolysiloxanes that are free, or virtually free, from volatile organic compounds (VOCs). These and other objects are achieved by means of the invention, wherein an organopolysiloxane bearing Si-bonded alkoxy or hydroxyl groups react in the dispersed phase with a reactive alkoxysilane, the alkoxysilane bearing at least one further group which increases the reactivity of the silane alkoxy groups.

### DETAILED DESCRIPTION OF THE PREFERRED EMBODIMENT(S)

The invention thus provides a process for preparing dispersions of crosslinked organopolysiloxanes by reacting at least one organopolysiloxane (1) containing Si-bonded alkoxy or hydroxyl groups with a highly reactive silane (2) containing Si-bonded alkoxy groups, or its partial hydrolyzates, the silane having a further group which raises the reactivity of the Si-alkoxy group in silane (2), and by means of which the initial viscosity of the mixture of (1) and (2) is at least doubled, preferably multiplied by at least five, over the course of 2 hours' reaction time at room temperature (21° C.), in the presence of a dispersion medium (3), preferably water, and emulsifier (4) and, if desired, further substances (5) which do not participate directly in the reaction, with the proviso that no metal-containing catalysts are used, and that the organopolysiloxanes in the dispersions obtained are crosslinked.

In the process of the invention the organopolysiloxanes (1) are preferably those composed of units of the general formula

$${{R}_{c} ( {OR}^{1} )}_{d} {SiO}_{\frac{4 - ( c + d )}{2}} \qquad ( I )$$

where
R is a hydrogen atom or a monovalent, saturated or unsaturated hydrocarbon radical which is unsubstituted or substituted by the elements N, P, S, O, Si, and halogen, and which has 1 to 200 carbon atoms, preferably 1 to 36 carbon atoms, per radical,
R¹ is a hydrogen atom or an alkyl radical having 1 to 8 carbon atoms, preferably a hydrogen atom or a methyl or ethyl radical,
c is 0, 1, 2 or 3, and
d is 0, 1 or 2,
   with the proviso that the sum c+d is ≦3 and in the organopolysiloxane (1) there is on average at least one radical OR¹ per molecule, preferably with R¹ being hydrogen.

In the process of the invention the highly reactive silane (2) is preferably one of the general formula
(AKT)ₐR²_{b}Si(OR³)_{4-(a+b)} (II)
or its partial hydrolyzates,
where
AKT is a monovalent radical, raising the reactivity of the Si—(OR³) bond, of the formula —CR⁴₂—Y or an alkenyl radical having 2 to 8 carbon atoms per radical,
R² is a monovalent, unsubstituted or substituted hydrocarbon radical having 1 to 18 carbon atoms per radical,
R³ is an alkyl or acyl radical having 1 to 8 carbon atoms per radical,
R⁴ is hydrogen or an alkyl radical having 1 to 4 carbon atoms, preferably hydrogen,
Y is a monofunctional radical from the group of halogens, monosubstituted atoms O and S, and substituted atoms N and P,
a is 1 or 2, preferably 1, and
b is 0, 1 or 2, preferably 0 or 1,
   with the proviso that the sum a+b is ≦3.

The invention further provides dispersions, preferably emulsions, of crosslinked organopolysiloxanes, preparable by reacting at least one organopolysiloxane (1) containing Si-bonded alkoxy or hydroxyl groups with a highly reactive silane (2) containing Si-bonded alkoxy groups, or its partial hydrolyzates, the silane having a further group which raises the reactivity of the Si-alkoxy group in silane (2), and by means of which the initial viscosity of the mixture of (1) and (2) is at least doubled, preferably multiplied by at least five, over the course of 2 hours' reaction time at room temperature (21° C.), in the presence of dispersion medium (3), preferably water, and emulsifier (4) and, if desired, further substances (5) which do not participate directly in the reaction, with the proviso that no metal-containing catalysts are used, and that the organopolysiloxanes in the dispersions obtained are crosslinked.

The invention further provides dispersions, preferably emulsions, of crosslinked organopolysiloxanes comprising crosslinked organopolysiloxanes composed of units of the general formula

$${AKT}_{n} {R}_{b}^{2} {{R}_{c} ( {OR}^{1} )}_{d} {SiO}_{\frac{4 - ( n + b + c + d )}{2}} \qquad ( III )$$

where AKT, R, R¹, R², b, c, and d are as defined above, and
n is 0, 1 or 2,
with the proviso that the sum n+b+c+d is ≦3, and that on average there is at least one radical AKT per molecule,
dispersion media (3), preferably water, and
emulsifiers (4), and if desired, further substances (5), which do not participate directly in the reaction, with the proviso that there are no metal catalysts present and that the organopolysiloxanes are crosslinked in the dispersions.

The crosslinked organopolysiloxanes of the invention have high molecular weight branched or dendrimerlike highly branched structures and this crosslinking results in hard or elastomeric compounds—hence no viscosity measurement is possible—and they are typically insoluble in organic solvents such as toluene, but possibly swell therein, such swelling likewise considered to represent insolubility for the purposes of this invention. This is in contrast to noncrosslinked organopolysiloxanes, which may also be of high viscosity, but in which viscosity measurement is possible and which are soluble in organic solvents such as toluene.

The fact that aqueous dispersions of crosslinked organopolysiloxanes can be obtained by the process of the invention was surprising, since A. Adima et al., Eur. J. Org. Chem. 2004, 2582-2588 describe how α-aminomethyltrialkoxysilanes decompose in the presence of water to form SiO₂ and the corresponding methylated amine.

The crosslinked organopolysiloxanes of the invention may have branched, dendrimerlike highly branched or crosslinked structures. These crosslinked organopolysiloxanes can be isolated from the dispersion as hard or elastomeric shaped bodies, for example as films.

The dispersions of the invention are preferably aqueous suspensions or aqueous emulsions of crosslinked organopolysiloxanes.

The dispersions of crosslinked organopolysiloxanes according to the invention dry to form a hard or elastic silicone network without addition of catalyst or alteration of pH. Preferably, for the preparation of the crosslinked organopolysiloxanes, only OH-terminal polyorganosiloxanes and rapidly reacting crosslinkers are used, and these components react with one another preferably at room temperature. To assist the reaction there is no need for additional metal-containing catalysts. Furthermore, the reaction proceeds preferably in the neutral range, i.e., in the pH range from approximately 5 to 8, which comes about as a result of the components themselves. As a result of the high reactivity, furthermore, there is no need for a controlled chemical reaction, and nor, preferably, for any heating. These dispersions may optionally include further components (5), such as water-miscible or water-immiscible liquids, silicone or nonsilicone emulsions, further silanes or silicones, as adhesion promoters for example, and also water-soluble or water-insoluble solids, especially water-insoluble solids, which serve as reinforcing or nonreinforcing fillers.

The dispersions of the invention are notable for their high storage stability, even at elevated temperatures, and for their high stability to shear. The process has the advantage that dispersions of low viscosity in tandem with high solids content and filler content can be obtained. The nonvolatile content of the dispersion is about 1% to 99% by weight, based on the total weight of the dispersion.

In the process of the invention no metal-containing catalysts are used; that is, there are preferably no transition metals from transition group VIII of the Periodic Table of the Elements, or their compounds, and no metals from main groups III, IV or V of the Periodic Table of the Elements, or their compounds, the elements C, Si, N and, and P not being regarded as metals for the purposes of this definition.

Examples of hydrocarbon radicals R are alkyl radicals such as the methyl, ethyl, n-propyl, isopropyl, 1-n-butyl, 2-n-butyl, isobutyl, tert-butyl, n-pentyl, isopentyl, neopentyl, and tert-pentyl radicals; hexyl radicals such as the n-hexyl radical; heptyl radicals such as the n-heptyl radical; octyl radicals such as the n-octyl radical and isooctyl radicals such as the 2,2,4-trimethylpentyl radical; nonyl radicals such as the n-nonyl radical; decyl radicals such as the n-decyl radical; dodecyl radicals such as the n-dodecyl radical; octadecyl radicals such as the n-octadecyl radical; cycloalkyl radicals such as the cyclopentyl, cyclohexyl, cycloheptyl, and methylcyclohexyl radicals; alkenyl radicals such as the vinyl, 5-hexenyl, cyclohexenyl, 1-propenyl, allyl, 3-butenyl, and 4-pentenyl radicals; aryl radicals such as the phenyl, naphthyl, anthryl and phenanthryl radicals; alkaryl radicals such as o-, m-, and p-tolyl radicals, xylyl radicals, and ethylphenyl radicals; and arylalkyl radicals such as the benzyl radical, and the α- and the β-phenylethyl radicals.

Preference is given as radical R to hydrogen or the methyl, ethyl, octyl, and phenyl radicals, particular preference being given to hydrogen or the methyl and ethyl radicals. Examples of halogenated radicals R are haloalkyl radicals, such as the 3,3,3-trifluoro-n-propyl radical, the 2,2,2,2′,2′,2′-hexa-fluoroisopropyl radical, the heptafluoroisopropyl radical, and haloaryl radicals, such as the o-, m- and p-chlorophenyl radicals.

Examples of radicals R¹ are the alkyl radicals listed above for R and also the methoxyethyl and ethoxyethyl radicals, the radical R¹ preferably being hydrogen or alkyl radicals having 1 to 18 carbon atoms which may be interrupted by oxygen atoms, more preferably hydrogen and the methyl and the ethyl radicals.

Examples of radicals R apply in full to radicals R², and preferred examples of radicals R³ are the methyl and ethyl radical.

Preferred organopolysiloxanes (1) used are siloxanes of the general formula
(R¹O)R₂SiO(SiR₂O)ₑSiR₂(OR¹) (IV)
where R and R¹ are as defined above, and
e is an integer from 1 to 1000,
with the proviso that 25% to 100%, preferably 50% to 100%, of all radicals R¹ are hydrogen atoms,
and also those siloxanes (resins) of the general formula
[(R₃SiO_{1/2})_{f}(R₂SiO_{2/2})_{g}(R₁SiO_{3/2})ₕ(SiO_{4/2})ₖ] (V)
where R is as defined above and additionally R in formula (V) may also be (OR¹) as defined above, with the proviso that there is at least one —OR¹ radical per molecule where R¹ is hydrogen, f, g, h, and k are each an integer from 0 to 1000, and h/(f+g+h+k) is preferably >0.2. Particular preference is given to using siloxanes of the formula (IV).

Examples of siloxanes (1) are commercially available polydimethylsiloxanes having terminal silanol groups and polydimethylsiloxanes having terminal alkoxy groups. Further examples of siloxanes (1) are commercially available functionalized siloxanes, such as amine oils, examples being amine oils having 3-(2-aminoethyl)aminopropyl functions, glycol oils, phenyl oils or phenylmethyl oils containing silanol or alkoxy groups.

Further examples of siloxanes (1) are resinous siloxanes, examples being methylsilicone resins, containing 80 mol % CH₃SiO_{3/2} and 20 mol % (CH₃)₂SiO_{2/2} and having a molecular weight of approximately 5000 g/mol, or 98 mol % CH₃SiO_{3/2} and 2 mol % (CH₃)₂SiO_{2/2} with a molecular weight of approximately 5000 g/mol, or, for example, methylphenylsilicone resins containing 65 mol % C₆H₅SiO_{3/2} and 35 mol % (CH₃)₂SiO_{2/2}, the remaining free valences carrying R¹O groups with the above definition.

These compounds are produced commercially in large quantities and are available at very favorable cost, thereby rendering the process of the invention particularly attractive from an economic standpoint. In the inventive process, a single type of organopolysiloxane (1) or different types of organopolysiloxanes (1) may be used.

The organopolysiloxanes (1) used in the process of the invention preferably have viscosities of 1 mPa·s to 50,000,000 mPa·s at 25° C., more preferably 50 mPa·s to 10,000,000 mPa·s at 25° C., and most preferably 100 mPa·s to 500,000 mPa·s at 25° C.

In the process of the invention, a single type of silane (2) or different types of silanes (2) may be used.

Examples of radicals Y are

fluorine, chlorine, bromine, or iodine,

the groups —OH or —OR⁵

the groups —SH or —SR⁵,

the groups —NH₂, —NHR⁵, —NR⁵₂ or 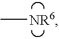
and
the groups —PR⁵₂, —P(OR⁵)₂, and —PO(OR⁵)₂ and
the groups —C(O)R⁵,
where R⁵ is a monovalent organic radical with or without N and/or O atoms, preferably a monovalent hydrocarbon radical having 1 to 18 carbon atoms with or without N and/or O atoms, and
R⁶ is a divalent hydrocarbon radical having 3 to 12 carbon atoms with or without N and/or O atoms.

Examples of radicals AKT are the hydroxymethyl, methoxymethyl, ethoxymethyl, 2-ethoxyethoxymethyl, 2-butoxyethoxymethyl, acetoxymethyl, mercaptomethyl, ethylthiomethyl, dodecylthiomethyl, aminomethyl, methylaminomethyl, dimethylaminomethyl, diethylamino-methyl, dibutylaminomethyl, cyclohexylaminomethyl, morpholinomethyl, piperidinomethyl, piperazinomethyl, ((diethoxymethylsilyl)methyl)cyclohexylaminomethyl, ((triethoxysilyl)methyl)cyclohexylaminomethyl, anilino-methyl, 3-dimethylaminopropylaminomethyl, bis(3-dimethylaminopropyl)aminomethyl, diethylphosphino-methyl, and dibutylphosphinomethyl radical, and groups of the formulae —CH₂NHCOR⁵, —CH₂NHCO₂R⁵ or —CH₂NHCONHR⁵, R⁵ being as defined above,

and the ethenyl, propenyl, isopropenyl, butenyl, butadienyl, pentenyl, hexenyl, and hexadienyl radicals.

Preferably AKT is a radical of the formula —CH₂NHR⁵, —CH₂NR⁵₂ or 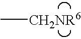
where R⁵ and R⁶ are as defined above.

Examples of hydrocarbon radicals R, such as alkyl, cycloalkyl, aryl, alkaryl and aralkyl radicals R, apply in full to hydrocarbon radicals R⁵. One preferred example of R⁶ is the radical of the formula
—CH₂—CH₂—O—CH₂—CH₂—.

Examples of silanes (2) are 2-butoxyethoxymethyltrimethoxysilane, methoxymethylmethyldiethoxysilane, diethylaminomethylmethyldimethoxysilane, dibutylaminomethyltriethoxysilane, dibutylaminomethyltributoxysilane, cyclohexylaminomethyltrimethoxysilane, cyclohexylaminomethyltriethoxysilane, cyclohexylaminomethylmethyldiethoxysilane, anilinomethyltriethoxysilane, anilinomethylmethyldiethoxysilane, morpholinomethyltriethoxysilane, morpholinomethyltrimethoxysilane, morpholinomethyltriisopropoxysilane, 3-dimethylaminopropylaminomethyltrimethoxysilane, acetylaminomethylmethyldimethoxysilane, ethylcarbamoylmethyltrimethoxysilane, (isocyanatomethyl)triethoxysilane, (isocyanatomethyl)trimethoxysilane (methacryloxymethyl)triethoxysilane, (methacryloxymethyl)trimethoxysilane, chloromethyltriethoxysilane, chloromethyltrimethoxysilane, morpholinomethyltributoxysilane, morpholinomethyltrialkoxysilane, the alkoxy radical being a C₁-C₄-alkoxy radical, in particular a mixture of methoxy and ethoxy radical, bis(dimethylaminopropyl)aminomethyltriethoxysilane, diisopropylaminomethyltriethoxysilane, diethylphosphonatomethyltrimethoxysilane, piperazinomethyltriethoxysilane, piperidinomethyltriethoxysilane, bis(diethoxymethylsilylmethyl)cyclohexylamine, bis(triethoxysilylmethyl)cyclohexylamine, mercaptomethyltriethoxysilane, and morpholinomethyltri(2-hydroxyethoxy)silane.

Preference is given to silanes (2) which carry a trialkoxy group, i.e., in which b in formula (II) is 0.

With respect to the process of the invention, it is preferred to use silanes (2) in amounts from 0.001% to 10% by weight, more preferably 0.01% to 5.0% by weight, most preferably 0.1% to 3.0% by weight, based in each case on siloxane (1).

Depending on whether di- or trialkoxysilane (2) or alkoxy- and hydroxy-group-bearing partial hydrolyzate of (2) and linear, branched or resinous siloxane (1) are employed, the crosslinked organopolysiloxanes may have branched or even highly branched/highly crosslinked structures with linear fractions.

Where dialkoxysilanes (2) are reacted with siloxanes (1) of purely linear construction, containing not more than 2 SiOH functions per molecule, in particular with the siloxanes of the formulae (IV), linear organopolysiloxanes of high viscosity are obtained, and not crosslinked organopolysiloxanes of the invention. The reaction of siloxanes (1) which contain more than 2 OH functions, in particular at least 3 OH functions, per molecule with dialkoxysilanes (2) does lead, in contrast, to crosslinked siloxane polymers.

Where trialkoxysiloxanes are used as silanes (2), which is preferred, crosslinked organopolysiloxanes of the invention are obtained. Furthermore, when using mixtures of dialkoxysilanes (2) and trialkoxysilanes (2), particularly when using mixtures of 1%-99% by weight dialkoxysilanes (2) and 1%-99% by weight trialkoxysilanes (2), preferably 10%-90% by weight dialkoxysilanes (2) and 10%-90% by weight trialkoxysilanes (2), crosslinked organopolysiloxanes of the invention are also obtained.

The degree of crosslinking depends on the ratio of the equivalents of —OR³ in silane (2) to —OR¹ in siloxane (1).

To prepare the dispersions of the invention which comprise crosslinked organopolysiloxanes from siloxane (1) and highly reactive silane (2), silane (2) or its partial hydrolyzates is used preferably in amounts of at least 0.6 equivalent of —OR³, preferably at least 0.7 equivalent of —OR³, more preferably 0.6 to 5 equivalents of —OR³, yet more preferably 0.65 to 2 equivalents of —OR³, and with particular preference 0.7 to 1.5 equivalents of —OR per equivalent of —OR¹ in siloxane (1), R¹ preferably being hydrogen.

The frequency of crosslinking depends not only on the chain lengths of siloxanes (1) but also on the stoichiometry of the interreacting SiOR¹ groups of the siloxane (1) and of the SiOR³ groups of the silane (2). High degrees of crosslinking are achieved when there is an equally large number of the SiOR¹ and SiOR³ groups reacting with one another. Losses as a result of volatility or secondary reactions may necessitate for this purpose a stoichiometric ratio which deviates from 1.0:1.0. If desired, it is possible to use a stoichiometric excess of SiOR³ to SiOR¹ groups. Surprisingly it has been found that, even with a stoichiometric deficit of SiOR³ groups relative to SiOR¹ groups, e.g., 0.7:1.0, elastic or hard films can be obtained.

Monofunctional monoalkoxysilanes react as chain stoppers and can then be used in addition to trialkoxysilanes or to mixtures of trialkoxysilanes and dialkoxysilanes if it is desired that there should be groups “W” at the end of siloxane chains. They are preferably not used.

The highly reactive silanes (2) are suitable for use in the invention when, for example, an α,ω-dihydroxypolydimethylsiloxane having a viscosity of 6350 mPas, measured at 25° C., as a representative of siloxane (1), is mixed with silane (2) in a ratio of the —OR³ to —OR¹ equivalents of 1 to 1.5 and this mixture, when left to stand at room temperature (21° C.), at least doubles its viscosity within 2 hours, i.e., the viscosity factor is ≦2; see table 1.

TABLE 1
A selection of inventive and noninventive silanes (2)

| | Ratio | Viscosity | Inven- |
|---|---|---|---|
| Silane (2) | −OR³/−OR¹ | factor¹⁾ | tive |
| Cyclohexylaminomethyltriethoxy- | 1 | >330* | yes |
| silane | | | |
| Morpholinomethyltriethoxysilane | 1 | 122 | yes |
| Dibutylaminomethyltrimethoxy- | 1 | >330* | yes |
| silane | | | |
| Piperazinomethyltriethoxysilane | 1 | >330* | yes |
| Bis(dimethylaminopropyl)amino- | 1 | 45 | yes |
| methyltriethoxysilane | | | |
| Bis(diethoxymethylsilylmethyl)- | 1 | >330* | yes |
| cyclohexylamine | | | |
| Bis(triethoxysilylmethyl)- | 1 | >330* | yes |
| cyclohexylamine | | | |
| 3-Aminopropyltrimethoxysilane | 1 | 1.21 | no |
| N-(2-Aminoethyl)(3-aminopropyl)- | 1 | 1.15 | no |
| trimethoxysilane | | | |
| Methyltrimethoxysilane | 1 | 1.1 | no |
| (Methacryloyloxymethyl)triethoxy- | 1 | 1.02 | no |
| silane | | | |

Measurement of the viscosity is performed at 21° C. with Brookfield DV-II+ viscometer

$${}^{( 1 )} Viscosity factor = \frac{( \begin{matrix}Viscosity of mixture of ( 1 ) and ( 2 ) \\ after 2 h at 21 ° C .\end{matrix} )}{( Viscosity of siloxane ( 1 ) employed )}$$

After only <30 minutes the mixtures have a very high viscosity and are outside the measurement range of the Brookfield viscometer.

The dispersions of crosslinked organopolysiloxanes according to the invention are prepared by intensely mixing siloxanes from the group of the siloxanes (1) with silanes (2), dispersion media (3), preferably water, and emulsifiers (4), and if desired, further substances (5) with one another. Preparation may take place continuously or batchwise.

Technologies for preparing dispersions or emulsions of organopolysiloxanes are known. Thus the intense mixing and dispersing may take place in rotor/stator stirring apparatus, colloid mills, high-pressure homogenizers, microchannels, membranes, jet nozzles and the like, or by means of ultrasound. Homogenizing apparatus and techniques are described for example in Ullmann's Encyclopedia of Industrial Chemistry, CD-ROM edition, 2003, Wiley-VCH Verlag, under the heading “Emulsions”.

Although, as is known, the silanes (2) contain groups which are sensitive to hydrolysis, particularly if R³ is a methyl, ethyl or acyl radical, it is surprising that, even in the presence of water, crosslinked organopolysiloxanes are obtained as a result of reaction with two or more siloxanes (1).

The way in which the components used to prepare the dispersions of the invention are mixed is not very critical and can be performed in various orders. However, depending on the components (1), (2), (3), (4), and (5), preferred procedures may come about which should be investigated for specific cases.

For example, components (1) and (2) may be premixed with one another, then the emulsifier(s) added, and subsequently the dispersion medium and any further substances (5) incorporated. Another possibility is to meter components (1) to (4) or (1) to (5) in order into the emulsifying apparatus. In particular cases, owing to the siloxanes viscosity or reactivity for example, it may be advantageous to mix silane (2) with a siloxane (1) and then to incorporate another siloxane (1), or vice versa, depending on what produces more favorable rheological properties for processing the components.

In the case of highly reactive silanes (2) it may be advantageous first to convert component (1) into a stiff phase with emulsifier (4) and the dispersion medium (3), and subsequently to meter in the silane (2) in pure form or in dilution in an inert substance (5), prior to a phase inversion. in order, for example, to produce an oil-in-water dispersion.

It is also possible, furthermore, to add silane (2) to the completed emulsion of siloxanes (1) in order thus to achieve the desired reaction and crosslinking of the siloxane (1) in the emulsion. The silane (2) can also be subjected beforehand, by addition of water, to partial or complete hydrolysis. In order to obtain VOC-free hydrolyzate of (2), the byproduct alcohol R³OH can be removed partly or fully by means of suitable, known measures such as distillation, membrane processes or other separation processes.

In the invention, the dispersion medium (3), preferably water, is preferably used in amounts of 1% to 99% by weight, more preferably 5% to 95% by weight, based in each case on the total weight of all ingredients of the dispersion.

Preferably the process for preparing crosslinked dispersions can be carried out continuously. In that case it is preferred to prepare the organopolysiloxanes (1) that are needed to prepare the dispersion continuously and to pass them on continuously to the emulsifying apparatus, and prior to emulsification to mix them continuously with silanes (2), emulsifiers (4), and at least part of the water as dispersion medium (3), this mixture being supplied directly and continuously to a first high-shear mixer, in which a viscous phase is formed, the pressure and the temperature being measured after this mixer and being regulated in such a way that a high-quality, very finely divided dispersion is formed.

For the process of the invention it is possible to use as emulsifiers (4), any suitable ionic or nonionic emulsifier, individually and in the form of mixtures of different emulsifiers, with which it is possible to prepare aqueous dispersions, especially aqueous emulsions of organopolysiloxanes. It is likewise possible, as is known, to use inorganic solids as emulsifiers (4). These are, for example, silicas or bentonites, as described in EP 1017745 A or DE 19742759 A.

Examples of anionic emulsifiers are as follows:

1. Alkyl sulfates, particularly those having a chain length of 8 to 18 carbon atoms, alkyl and alkaryl ether sulfates having 8 to 18 carbon atoms in the hydrophobic radical and 1 to 40 ethylene oxide (EO) and/or propylene oxide (PO) units.

2. Sulfonates, particularly alkylsulfonates having 8 to 18 carbon atoms, alkylarylsulfonates having 8 to 18 carbon atoms, taurides, esters, including monoesters, of sulfosuccinic acid with monohydric alcohols or alkylphenols having from 4 to 15 carbon atoms; if desired, these alcohols or alkylphenols may also have been ethoxylated with 1 to 40 EO units.

3. Alkali metal salts and ammonium salts of carboxylic acids having 8 to 20 carbon atoms in the alkyl, aryl, alkaryl or aralkyl radical.

4. Phosphoric acid partial esters and their alkali metal salts and ammonium salts, particularly alkyl and alkaryl phosphates having 8 to 20 carbon atoms in the organic radical, alkyl ether phosphates and alkylaryl ether phosphates having 8 to 20 carbon atoms in the alkyl or alkaryl radical and 1 to 40 EO units.

Examples of nonionic emulsifiers are as follows:

5. Polyvinyl alcohol still containing 5% to 50%, preferably 8% to 20%, of vinyl acetate units, with a degree of polymerization of 500 to 3000.

6. Alkyl polyglycol ethers, preferably those having 3 to 40 EO units and alkyl radicals of 8 to 20 carbon atoms.

7. Alkylaryl polyglycol ethers, preferably those having 5 to 40 EO units and 8 to 20 carbon atoms in the alkyl and aryl radicals.

8. Ethylene oxide/propylene oxide (EO/PO) block copolymers, preferably those having 8 to 40 EO/PO units.

9. Adducts of alkylamines having alkyl radicals of 8 to 22 carbon atoms with ethylene oxide or propylene oxide.

10. Fatty acids having 6 to 24 carbon atoms.

11. Alkylpolyglycosides of the general formula R*—O-Zₒ, in which R* is a linear or branched, saturated or unsaturated alkyl radical having on average 8-24 carbon atoms and Zₒ is an oligoglycoside residue containing on average o=1-10 hexose or pentose units or mixtures thereof.

12. Natural substances and derivatives thereof, such as lecithin, lanolin, saponins, cellulose; cellulose alkyl ethers and carboxyalkylcelluloses whose alkyl groups each possess up to 4 carbon atoms.

13. Linear organo(poly)siloxane-containing polar groups containing in particular the elements O, N, C, S, P, Si especially those having alkoxy groups with up to 24 carbon atoms and/or up to 40 EO and/or PO groups.

Examples of cationic emulsifiers are as follows:

14. Salts of primary, secondary, and tertiary fatty amines having 8 to 24 carbon atoms with acetic acid, sulfuric acid, hydrochloric acid, and phosphoric acids.

15. Quaternary alkylammonium and alkylbenzeneammonium salts, especially those whose alkyl groups possess 6 to 24 carbon atoms, particularly the halides, sulfates, phosphates, and acetates.

16. Alkylpyridinium, alkylimidazolinium, and alkyloxazolinium salts, especially those whose alkyl chain possesses up to 18 carbon atoms, particularly the halides, sulfates, phosphates, and acetates.

Particularly suitable ampholytic emulsifiers include the following:

17. Amino acids with long-chain substitution, such as N-alkyl-di(aminoethyl)glycine or N-alkyl-2-aminopropionic salts.

18. Betaines, such as N-(3-acylamidopropyl)-N,N-dimethylammonium salts having a C₁-C₁, acyl radical, and alkylimidazolium betaines.

Preferred emulsifiers are nonionic emulsifiers, especially the alkyl polyglycol ethers listed above under 6.

Constituent (4) may be composed of one of the abovementioned emulsifiers or of a mixture of two or more abovementioned emulsifiers, and may be used in pure form or as solutions of one or more emulsifiers in water or organic solvents.

In the process of the invention the emulsifiers (4) are used in amounts of preferably 0.1% to 60% by weight, more preferably 0.5% to 30% by weight, based in each case on the total weight of siloxanes (1) and silanes (2).

If the organopolysiloxane (1) or the silane (2) or the resultant crosslinked organopolysiloxane itself acts as an emulsifier, it is possible to forego the addition of separate emulsifier (4).

Examples of water-miscible liquids which can be used as further substances (6) are acids such as formic acid, acetic acid, propionic acid, phosphoric acid, hydrochloric acid, or sulfuric acid, or bases such as triethylamine, triethanolamine, trioctylamine, and additionally ethylene glycol or polyethylene glycol, 1,2-propanediol, 1,3-propanediol, polypropylene glycol, diethylene glycol monobutyl ether, or glycerol. It is further possible to use dispersions or emulsions as further substances (5), examples being commercially available dispersions such as styrene-butadiene latex, acrylic, vinyl, polyurethane or polyethylene dispersions, and also emulsions or natural or synthetic oils, resins or waxes, such as carnauba wax, beeswax, lanolin, aloe vera, vitamin E, liquid paraffin, unreactive silicone oil, unreactive silicone resin, jojoba oil, rice oil, calendula oil, tea tree oil, rose oil or balm oil emulsions. As further substances (5) it is additionally possible to add commercially customary preservatives for dispersions, such as isothiazolinones or parabens, for example, or aqueous formulations thereof.

The dispersions can be prepared as dispersions of undiluted crosslinked organopolysiloxanes, although in certain cases, for reasons of handling, dilution is advisable with organic solvents or low-viscosity oligomers/polymers.

Examples of water-immiscible liquids which can be used as further substances (5) are therefore organic solvents, such as toluene, n-hexane, n-heptane, and technical petroleum fractions, and low-viscosity oligomers/polymers, preferably siloxanes, such as dimethylpolysiloxanes.

Examples of water-soluble solids which can be used as further substances (5) are, for example, inorganic salts such as alkali metal or alkaline earth metal halides, sulfates, phosphates, hydrogen phosphates, e.g., sodium chloride, potassium sulfate, magnesium bromide, calcium chloride, ammonium chloride, and ammonium carbonate, or salts of C₁ to C₈ carboxylic acids such as alkali metal or alkaline earth metal salts, e.g., sodium acetate.

Examples of water-insoluble solids which can be used as further substances (5) are reinforcing and nonreinforcing fillers. Examples of reinforcing fillers, which are fillers having a BET surface area of at least 50 m²/g, are pyrogenic silica, precipitated silica or silicon aluminum mixed oxides having a BET surface area of more than 50 m²/g. These fillers may have been rendered hydrophobic. Examples of nonreinforcing fillers, which are fillers having a BET surface area of less than 50 m²/g, are powders of quartz, chalk, crystobalite, diatomataceous earth, calcium silicate, zirconium silicate, montmorillonites, such as bentonites, zeolites, including the molecular sieves such as sodium aluminum silicate, metal oxides such as aluminum oxide or zinc oxide or their mixed oxides or titanium dioxide, metal hydroxides such as aluminum hydroxide, barium sulfate, calcium carbonate, gypsum, silicon nitride, silicon carbide, boron nitride, powdered glass, powdered carbon, and powdered plastics, and hollow glass and plastic beads.

The emulsifying operation for preparing the dispersion is preferably carried out at temperatures below 120° C., more preferably at 5° C. to 100° C., and most preferably at 10° C. to 80° C. The temperature increase preferably comes about through the introduction of mechanical shearing energy which is required for the emulsifying operation. The temperature increase is not needed in order to accelerate a chemical process. Furthermore, the process of the invention is preferably carried out under the pressure of the surrounding atmosphere, though it can also be carried out at higher or lower pressures.

The process of the invention has the advantage of proceeding without the use of catalysts, especially without the use of metal catalysts. The reaction of (1) with (2) proceeds to completion preferably within a few minutes to several hours, with methoxysilanes reacting more rapidly than ethoxysilanes here as well. The condensation can, however, be accelerated by means of acids and bases, although this is not preferred.

The alcohols obtained as condensation byproducts in the process of the invention may remain in the product or else can be removed, by means of vacuum distillation, membrane process or extraction, for example.

The average particle size measured by means of light scattering within the dispersions is situated in the range 0.001 to 100 μm, preferably 0.002 to 10 μm. The pH values may vary from 1 to 14, preferably 3 to 9, more preferably 5 to 8.

The invention further provides shaped bodies through removal of the dispersion medium (3), preferably water, from the dispersions of the invention, preferably emulsions. In this case it is preferred to remove the water by drying the dispersions of the invention at a temperature of 1 to 200° C., preferably 5 to 150° C., more preferably in the temperature range of the surrounding atmosphere, i.e., at approximately 10 to 30° C.

The drying time in this case depends on the thickness of the shaped body and is preferably 0.1 to 200 hours, more preferably 0.2 to 48 hours.

The shaped bodies may be hard or elastomeric bodies. They are preferably coatings or self-supporting shaped bodies, such as self-supporting films. It is also possible to obtain hard or elastomeric powders by removing the dispersion medium (3), preferably water, by spray drying, fluid-bed drying or freeze drying from the dispersions.

The invention further provides a method of producing coatings by applying the dispersion of the invention to a substrate and removing the dispersion medium (3), preferably water. The dispersion is preferably dried on the substrate.

In contrast to coatings, self-supporting films do not adhere to the substrate on which they have been produced, and can be removed from the substrate.

The invention further provides a method of impregnating or infiltrating substrates by applying the dispersion of the invention to a substrate, impregnating or infiltrating the substrate or its surface, and removing the dispersion medium (3), preferably water. The dispersion is preferably dried on the substrate.

With regard to the substrates, the dispersions of the invention may remain substantially on the surface, and the substrate is impregnated, or else the dispersions may penetrate more deeply into the substrate, providing infiltration.

The application of the dispersions of the invention to the substrates that are to be coated or to the substrates or surfaces thereof that are to be impregnated or infiltrated can take place in any desired way which is suitable for the production of coatings or impregnated systems from liquid materials, such as by dipping, spreading, pouring, spraying, rolling, printing, by means of an offset gravure coating apparatus, for example, by blade or knife coating, or by means of an air brush, for example. The coat thickness on the substrates to be coated is preferably 0.01 to 10 000 μm, more preferably 0.1 to 100 μm.

Examples of substrates which can be infiltrated or impregnated or coated with the dispersions of the invention include paper, wood, cork, plastics, polymeric films, such as polyethylene films, or polypropylene films, polyethylene-coated paper and boards, natural or synthetic fibers, woven and nonwoven cloth of natural or synthetic fibers, textiles, ceramic articles, glass, including glass fibers, stone, concrete, and metals.

The dispersions of the invention can additionally be used as silicone sealants, as PSAs (pressure-sensitive adhesives), and in personal care compositions.

### Example 1

In an Ultra-Turrax T 50 emulsifier (Janke & Kunkel) 5 g of isotridecyl decaethoxylate, 85% in water, available commercially under the trade name Lutensol TO 109 (BASF), and 8 g of demineralized water are used to produce an emulsifier mixture, to which 100 g of a freshly prepared homogeneous siloxane polymer/silane mixture are added, consisting of 99.65 g of polydimethylsiloxanediol having a terminal OH group content of 1100 ppm by weight, as siloxane (1a), and 0.39 g of N-morpholinomethyltriethoxysilane as silane (2). Dilution is then carried out in portions with a total of 90.1 g of fully demineralized water, to give a milky white emulsion having an average particle size of 309 nm. The solids content of the emulsion is 50.7%, its pH 6.0. The emulsion remains homogeneous and stable even after 6-month storage at room temperature.

Evaporating the emulsion after a drying time of 24 h at 25° C. produces a film of gel-like elasticity which has adhesive properties and adheres well to glass or aluminum.

### Examples 2 to 6

Further emulsions are prepared in the same way as in Example 2, using the amounts indicated in table 2:

TABLE 2

| | Siloxane | Silane | Solids | | Particle | Film assessment |
|---|---|---|---|---|---|---|
| Exam- | (1) | (2) | content | | size | after drying |
| ple | in g | in g | (%) | pH | (nm) | 24 h/25° C. |
| E2 | 99.56 (1a) | 0.44 | 50.5 | 7 | 478 | very elastic, |
| | | | | | | transparent |
| E3 | 99.40 (1a) | 0.60 | 49.9 | 7 | 481 | elastic, |
| | | | | | | transparent |
| E4 | 99.22 (1a) | 0.79 | 50.5 | 6.5 | nd* | elastic, opaque, |
| | | | | | | little adhesion |
| E5 | 94.0 (1a) | 6.0 | 49.8 | 8 | nd* | little elasticity, |
| | | | | | | opaque |
| E6 | 20.0 (1b) | 0.37 | 52.0 | 7 | 2810 | very elastic, |
| | | | | | | transparent |
| | 80.0 (1a) | | | | | tacky |

*nd = not determined

The solids content is determined to constant weight at 150° C. using the Mettler Toledo HR 73 apparatus.

The particle sizes are determined using a Coulter N4 plus.

Siloxane (1b) used is a copolymer of 3-(2-aminoethylamino)propylmethylsiloxy and dimethylsiloxy units with an amine number of 0.145, a viscosity of 4700 mm²/s (at 25° C.), and an OH/OMe end group ratio of 54/46.

Siloxane (1a) used is a polydimethylsiloxanediol having a terminal OH group content of 1100 ppm by weight.

Silane (2) used is N-Morpholinomethyltriethoxysilane.

The elasticity of the films produced from the emulsion decreases with increasing amount of silane (2) from E1 to E5.

The elastomer film produced from dispersion E3 is cut and placed in toluene for 24 h. Thereafter the cut edges are still sharply defined. The film has swollen but is insoluble in toluene.

### Example 7

In an Ultra-Turrax T 50 emulsifier (Janke & Kunkel) 2.5 g of isotridecyl decaethoxylate (Lutensol TO 109, BASF), and 8 g of water are used to prepare an emulsifier mixture to which 99 g of a freshly prepared homogeneous siloxane/silane mixture are added consisting of 97.56 g of polydimethylsiloxanediol (1a), 1.0 g of siloxane (1b), and 0.44 g of N-morpholinomethyltriethoxysilane. Dilution is then carried out in portions with a total of 8.9 g of water, to give a pastelike, milky white emulsion of firm consistency. The solids content of the emulsion is 86.3%. The emulsion paste remains homogeneous and stable even after 8-month storage at room temperature.

Evaporation of the emulsion at 25° C. produces skinning after just 45 minutes, and after 5 hours its state is virtually that of a compact film. After 24 h at 25° C. an elastic film is obtained which adheres to glass, paper or aluminum. The values measured on a standard dumbell S3A to DIN 53504-85 are as follows: breaking extension 680%, stress value at 100% elongation 0.11 N/mm².

The emulsion paste is suitable for use as a joint sealant.

### Example 8

In an Ultra-Turrax T 50 emulsifier (Janke & Kunkel) 4 g of isotridecyl pentadecaethoxylate, available commercially under the trade name Lutensol TO 15 (BASF), and 8 g of water are used to prepare an emulsifier mixture to which 100 g of a freshly prepared homogeneous siloxane/silane mixture are added consisting of 97.05 g of a silicone resin (2Si NMR: 72.7 mol % CH₃SiO_{3/2}, 1.6 mol % (CH₃)₂SiO_{2/2}, and 25.7 mol % (CH₃)₃SiO_{1/2}; Zerewitinoff OH content: 5.8% by weight; viscosity 2640 mm²/s and 3.0 g of cyclohexylaminomethyltriethoxysilane. Dilution is then carried out in portions with a total of 89.9 g of water, giving a milky white emulsion. The solids content of the emulsion is 47.9%. The emulsion remains homogeneous and stable even after 5-month storage at room temperature.

Evaporating the emulsion at 25° C. produces within 24 h a hard, transparent film of low elasticity which exhibits outstanding adhesion to glass, paper, aluminum or concrete.

### Example 9

In the same way as in Example 1 a dispersion is prepared, using the following components:

5 g of isotridecyl decaethoxylate (Lutensol TO 109, BASF); 8 g of fully demineralized water; 100.65 g of a siloxane/silane mixture freshly prepared from

97.5 g of siloxane (1c) (polydimethylsiloxanediol having a terminal OH group content of 740 ppm by weight), 0.45 g of N-morpholinomethyltriethoxysilane, and, additionally as substance (5), 2.5 g of N-(2-aminoethyl)(3-aminopropyl)methyldimethoxysilane; 90.1 g of fully demineralized water.

A milky white emulsion is formed. The solids content of the emulsion is 52.7%, its pH 8.5. The emulsion remains homogeneous and stable even after 3-month storage at room temperature.

Evaporating the emulsion at 25° C. produces within 24 h an elastic film which adheres well to glass, paper or aluminum. The silicone liner provided by this film is impeccable on paper and exhibits good release properties with respect to commercially customary adhesive labels.

### Example 10

In the same way as in Example 1 a dispersion is prepared, using the following components:

8.1 g of partly hydrophobicized silica, prepared in accordance with EP 1 433 749 A1, in dispersion in 43.9 g of fully demineralized water,

99.0 g of a siloxane/silane mixture, freshly prepared from

1.0 g of siloxane (1b), 97.56 g of siloxane (1a), and 0.44 g of N-morpholinomethyltriethoxysilane, and

45.8 g of fully demineralized water.

A milky white emulsion is formed. The solids content of the emulsion is 52.1%, its pH 5.5. The emulsion remains homogeneous and stable even after 3-month storage at room temperature.

Evaporating the emulsion produces, after a drying time of 24 h at 25° C., an elastic film which adheres to glass and aluminum.

### Example 11

In the same way as in Example 1 a dispersion is prepared, using the following components:

8.25 g of isotridecyl pentaethoxylate (Lutensol TO 5, BASF);

10.34 g of isotridecyl decaethoxylate (Lutensol TO 109, BASF);

16.5 g of Tagat S (1:1 in water), (Goldschmidt AG)

724.0 g of a siloxane/silane mixture, freshly prepared from

720.2 g of siloxane (1a), 3.98 g of N-morpholinomethyltriethoxysilane;

596.5 g of fully demineralized water.

A milky white emulsion is formed. The solids content of the emulsion is 53.8%, its pH 6.5. The emulsion remains homogeneous and stable even after 6-month storage at room temperature.

Evaporating the emulsion produces, after a drying time of 24 h at 25° C., an elastic, opaque film.

### Example 12

### Emulsion A

In the same way as in Example 1 a dispersion is prepared, using the following components:

5 g of isotridecyl decaethoxylate (Lutensol TO 109, BASF);

8 g of fully demineralized water;

100.0 g of a siloxane/silane mixture, freshly prepared from

94 g trimethylsilyl-end stoppered polydimethylsiloxane having a viscosity of 98 mm²/s and

6.0 g of N-morpholinomethyltriethoxysilane;

90.0 g of fully demineralized water.

### Emulsion B

In the same way as in Example 1 a dispersion is prepared, using the following components:

5 g of isotridecyl decaethoxylate (Lutensol TO 109, BASF);

8 g of fully demineralized water;

98.0 g of siloxane (1a);

90.0 g of fully demineralized water.

Emulsion A and emulsion B, both of which are milky white, are mixed in a ratio of 50:8 parts by weight.

By evaporation of the emulsion mixture, after a drying time of 24 h at 25° C., an elastic, readily adhering film is obtained whose surface is smooth to the touch.

### Example 13

50 parts by weight of emulsion A from Example 12 are mixed with 8 parts by weight of the emulsion from Example 5. By evaporation of the emulsion mixture, after a drying time of 3 days at 25° C., an elastically tacky film is obtained which adheres well.

### Example 14

To produce a microemulsion of an amine-containing, crosslinked silicone, first of all a homogeneous emulsifier mixture is prepared from 1.5 g of diethylene glycol monobutyl ether, 3.3 g of Lutensol TO 5 (BASF), 0.3 g of Marlipal ST 1618/25 (Sasol GmbH, Marl) and 0.07 g of 80% strength acetic acid.

Incorporated into this premix with stirring is a fresh solution prepared from 0.055 g of N-morpholinomethyltriethoxysilane, 8.0 g of siloxane (1b) and 2.0 g of siloxane (1a), and then the mixture is slowly diluted with 14.5 g of deionized water. This gives a highly mobile, transparent microemulsion.

Approximately 2 g of the microemulsion are dried at 50° C. Skinning has commenced after 1 hour. After a drying time of 5 hours at 50° C. an elastically tacky, opaque silicone film which adheres well has formed.

### Example 15

To produce a microemulsion of a crosslinked silicone, 4 g of emulsion from Example 7 are mixed with 1.5 g of 1,2-propanediol. This produces a highly mobile, virtually clear emulsion of crosslinked silicone.

Evaporating the emulsion produces, after a drying time of 72 h at 20° C., an elastic, opaque film with a surface which is dry to the touch.

### Example 16

4 parts by weight of a pyrogenic, highly disperse, hydrophilic silica (BET surface area: 150 m²/g) are mixed into 96 parts by weight of the emulsion from Example 7. A flowable powder is formed. After a drying time of 4 hours at 25° C. this mixture forms an elastic powder.

### Example 17

52 parts by weight of the emulsion from Example 7 are diluted with 34 parts by weight of water and the diluted emulsion is mixed with 4.3 parts by weight of an SBR dispersion (type 85PI6 from Synthomer Ltd., Harlow, GB) as further component (5).

Evaporating this mixture produces, after a drying time of 24 h at 25° C., an elastic film which adheres well to glass.

### Example 18

8 parts by weight of the emulsion from Example 7 are mixed with 1 part by weight of a 10% strength solution of polyvinyl alcohol in water (degree of hydrolysis of the PVA: 88%, viscosity of the 10% strength solution at 25° C.: 950 mm²/sec) as component (5).

Evaporating this mixture produces, after a drying time of 24 h at 25° C., an elastic film which adheres well to glass and aluminum.

### Example 19

In the same way as in Example 1 a dispersion is prepared, using the following components:

2.5 g of isotridecyl decaethoxylate (Lutensol TO 109, BASF);

8 g of fully demineralized water;

70.15 g of a siloxane/silane mixture, freshly prepared from

69.92 g of siloxane (1d) (polydimethylsiloxanediol having a terminal OH group content of 1900 ppm by weight), 0.23 g of N-morpholinomethyltriethoxysilane, and additionally as substance (5), 30 g of a trimethylsilyl-endstoppered polydimethylsiloxane having a viscosity of 102 mm²/s;

90.0 g of fully demineralized water.

A milky white emulsion is formed. The solids content of the emulsion is 51.7%, its pH 6.5. The emulsion remains homogeneous and stable even after 3-month storage at room temperature.

Evaporating the emulsion produces, after a drying time of 48 h at 23° C., an elastic film.

### Example 20

Example 1 is repeated in the same spirit with the difference that this time, instead of a mixture of siloxane (1a) and silane (2), 69.6 g of pure polydimethylsiloxanediol having a terminal OH group content of 1100 ppm by weight (described in Example 1), in three portions, and subsequently 30.39 g of a solution of 0.39 g of N-morpholinomethyltriethoxysilane in 30.00 g of a trimethylsilyl-endstoppered polydimethylsilicone oil with a viscosity of 350 mPa·s (25° C.), in two portions, are added. This is followed by identical dilution with water.

With the same silicone content and solids content, the emulsion has a particle size of 294 nm. The emulsion shows no change after 5 days at 50° C.

### Example 21

Mixed into 100 g of a commercial emulsion (Finish CT 45 E), containing as siloxane (1b) about 36% by weight of a copolymer composed of 3-(2aminoethylamino)propylmethylsiloxy units and dimethylsiloxy units, having an amine number of 0.145, a viscosity of 4700 mm²/s (at 25° C.) and an OH/OMe endgroup ratio of 54/46, 5% of isotridecyl decaethoxylate, 85% strength in water, as emulsifier (4), available commercially under the trade name Lutensol TO 109 (BASF), and also 0.2% of acetic acid (80% strength) and 0.1% of a commercial aqueous preservative based on isothiazolinones, as further substances (5), the remainder to 100% being fully demineralized water as dispersion medium (3), is 0.4 g of N-morpholinomethyltriethoxysilane. After 2 hours of standing time, 6 g of the mixture are poured into a Petri dish of 5 cm in diameter. After the dish has been left to stand at room temperature for 30 hours, 2.3 g of a white, elastic film are formed.

### Example 22

Continuous preparation of the siloxane (1a) and continuous preparation of the dispersion:

Siloxane (1a) is prepared continuously as per example 3 in EP 626 415 A1 and is passed on continuously to the emulsifying apparatus. Added continuously to 97.6 parts of the siloxane (1a), at a temperature of approximately 20° C., are 1.0 part of siloxane (1b), 0.44 part of N-morpholinomethyltriethoxysilane, 2.5 parts of isotridecyl decaethoxylate (Lutensol TO 109, BASF), 6 parts of fully demineralized water, and 0.2 part of Kathon® LXE (preservative). This mixture is supplied directly and continuously to a first high-shear mixer of the toothed gear mixer type, in which a viscous phase is formed.

The pressure and the temperature are measured after this mixer and are regulated so as to give a high-quality, very finely divided emulsion.

This produces a translucent dispersion paste of high viscosity with a solids content of 91.5%. The paste can be dispensed directly into containers or else mixed with other substances or, if necessary, diluted further with water.

For testing purposes, the paste is coated out as a thin film on glass. One paste coating is immediately tested to determine whether the concentrated but not yet initially dried paste can be removed with water. Result: the not initially dried paste is readily removable with water.

Skinning is tested on a further paste coating. Result: after 20 minutes, skinning occurs. After 24 hours an elastic film has formed which adheres to glass. The paste can be used as a joint-sealing composition.

Comparative Experiment 1 (not Inventive)

Example 1 is repeated in the same spirit with the difference that this time, instead of the siloxane polymer/silane mixture used in Example 1, 100 g of a freshly prepared homogeneous siloxane polymer/silane mixture consisting of 99.65 g of polydimethylsiloxanediol having a terminal OH group content of 1100 ppm by weight and 0.59 g of N-(2-aminoethyl)(3-amino-propyl)trimethoxysilane are added. This is followed by identical dilution with water, giving a milky white, homogeneous emulsion having an average particle size of 362 nm and a pH of 7.

Evaporating the emulsion produces, even after a drying time of 12 days at 23° C., only an oil, which is soluble in toluene, but not a film possessing elastomeric properties.

Comparative Experiment 2 (not Inventive)

In an Ultra-Turrax emulsifier T 50 (Janke & Kunkel) 9.38 g of isotridecyl decaethoxylate (Lutensol TO 109, BASF AG), 3.90 g of castor oil ethoxylate G 1300 (Atlas) and 4.55 g of water are used to produce a stiff emulsifier mixture, to which 125.28 g of a freshly prepared homogeneous polymer/silane mixture composed of 124.63 g of polydimethylsiloxanediol having a terminal OH group content of 765 ppm by weight and 0.86 g of N-morpholylmethylmethyldiethoxysilane is added. Dilution is then carried out in portions with a total of 106.65 g of water, giving a stable emulsion having an average particle size of 275 nm. The silicone content of the emulsion is 50%.

Following a standing time of 24 h at 25° C., and re-extraction of the siloxane polymer with n-heptane, the emulsion is evaporated and loses the solvent to give a highly viscous polysiloxane having a viscosity of 3400 Pa·s (25° C.) which is soluble in toluene and hence uncrosslinked. The dispersion comprising this highly viscous polysiloxane is not inventive.

Comparative Experiments 3a and 3b with Vinyltriacetoxysilane:

The procedure of Example 3 is repeated, with the modification that

a) 0.53 g of vinyltriacetoxysilane (molar mass: 232.3) per 100 g of dihydroxypolydimethylsiloxane (1a) with a terminal OH group content of 1100 ppm by weight, corresponding to an —OR³/—OR¹ ratio of 1.1 (in analogy to Example 3);

b) the amount of vinyltriacetoxysilane used in Example 8 of U.S. Pat. No. 5,994,459 (i.e. 2.63 g of vinyltriacetoxysilane, converted equivalently to the OH content of 1100 ppm by weight of the dihydroxypolydimethylsiloxane (1a) employed)

are employed.

Evaporating the emulsion produces in each case, after a drying time of 24 h at 25° C., a strongly tacky, oily mass. When placed in toluene, the viscous, oily masses thus obtained undergo immediate swelling, break down into very small fragments, and after 4 h are virtually invisible. The polymers have therefore undergone predominant dissolution in toluene.

The emulsions obtained according to Comparison 3a and 3b have a pH of 3.5 (as a result of elimination of acetoxy groups to form acetic acid) and are unstable. After a week of storage at room temperature they have separated into 2 phases.

TABLE 1a
Comparative experiments with non-inventive silanes (2)

| | −OR³/−OR¹ | Viscosity | |
|---|---|---|---|
| Silane (2) | ratio | factor¹⁾ | Inventive |
| Vinyltrimethoxysilane | 1 | 1.09 | no |
| Methoxymethyltrimethoxy- | 1 | 1.01 | no |
| silane | | | |
| Isooctyltrimethoxysilane | 1 | 1.12 | no |
| Phenyltriethoxysilane | 1 | 1.04 | no |

Measurement of the viscosity at 21° C. with Brookfield DV-II+ viscometer

$${}^{( 1 )} Viscosity factor = \frac{\begin{matrix}( Viscosity of mixture of ( 1 ) and ( 2 ) \\ after 2 h at 21 ° C .\end{matrix}}{( Viscosity of siloxane ( 1 ) employed )}$$

The silanes (2) are only suitable and inventive when, for example, an α,ω-dihydroxypolydimethylsiloxane having a viscosity of 6350 mPas, measured at 25° C., as a representative of siloxane (1), is mixed with silane (2) in a ratio of equivalents, —OR³ to —OR¹, of 1, and if this mixture, when left to stand at room temperature (21° C.), at least doubles its viscosity within 2 hours, i.e., the viscosity factor is ≧2. According to Table 1a the viscosity factor is approximately 1, meaning that the silanes vinyltrimethoxysilane, methoxy-methyltrimethoxysilane, isooctyltrimethoxysilane, and phenyltriethoxysilane are not inventive.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A process for preparing a dispersion of crosslinked organopolysiloxanes, comprising reacting
at least one organopolysiloxane (1) containing Si-bonded alkoxy or hydroxyl groups
with a highly reactive silane (2) containing Si-bonded alkoxy groups, or its partial hydrolyzates,
the silane having a further group which raises the reactivity of the Si-alkoxy group in silane (2) by means of which the initial viscosity of the mixture of (1) and (2) is at least doubled over the course of 2 hours' reaction time at 21° C.,
in the presence of dispersion medium (3),
and emulsifier (4)
and optionally further substances (5) which do not participate in the reaction,
to form a dispersion, with the provisos that no metal-containing catalysts are used, and
the organopolysiloxanes in the dispersions obtained are crosslinked.

2. The process of claim 1, wherein the dispersion medium comprises water.

3. The process of claim 1, wherein at least one organopolysiloxane (1) comprises units of the formula
$${{R}_{c} ( {OR}^{1} )}_{d} {SiO}_{\frac{4 - ( c + d )}{2}} \qquad ( I )$$
where
R is hydrogen or a monovalent, saturated or unsaturated C₁₋₂₀₀ hydrocarbon radical which is unsubstituted or substituted by the elements N, P, S, O, Si, and halogen,
R¹ is hydrogen or a C₁₋₈ alkyl radical,
c is 0, 1, 2 or 3, and
d is 0, 1 or 2,
with the proviso that the sum c+d is ≦3 and in the organopolysiloxane (1) there is on average at least one radical OR¹ per molecule.

4. The process of claim 3, where at least one R¹ is hydrogen.

5. The process of claim 1, wherein organopolysiloxane(s) (1) comprise those of the formula
(R¹O)R₂SiO(SiR₂O)ₑSiR₂(OR¹) (IV)
where e is an integer from 1 to 1000,
with the proviso that 50% to 100% of all radicals R¹ are hydrogen atoms.

6. The process of claim 1, wherein the highly reactive silane(s) (2) comprise those of the formula
(AKT)ₐR²_{b}Si(OR³)_{4-(a+b)} (II)
where
AKT is a monovalent radical which raises the reactivity of the Si—(OR³) bond, of the formula —CR⁴₂—Y or a C₂₋₈ alkenyl radical,
R² is a monovalent, unsubstituted or substituted C₁₋₁₈ hydrocarbon radical,
R³ is a C₁₋₈ alkyl or C₁₋₈ acyl radical,
R⁴ is hydrogen or a C₁₋₄ alkyl radical,
Y is a monofunctional radical selected from the group consisting of halogens, monosubstituted O and S, and
substituted N and P,
a is 1 or 2, and
b is 0, 1 or 2,
with the proviso that the sum a+b is ≦3.

7. The process of claim 6, wherein R⁴ is hydrogen.

8. The process of claim 1, wherein a trialkoxy silane where b is 0 is used as silane (2).

9. The process of claim 4, wherein the radical AKT is a radical of the formula —CH₂NHR⁵, —CH₂NR⁵₂ or 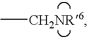
in which R⁵ is a monovalent C₁₋₁₈ hydrocarbon radical optionally containing N and/or O atoms, and R⁶ is a divalent hydrocarbon radical having 3 to 12 carbon atoms optionally containing N and/or O atoms.

10. The process of claim 1, wherein silane (2) is used in amounts such that there are 0.6 to 5 equivalents of —OR³ per equivalent of —OR¹ in organopolysiloxane (1), R¹ being a hydrogen atom.

11. The process of claim 9, wherein water is used as dispersion medium (3).

12. The process of claim 1, wherein the organopolysiloxane(s) (1) are prepared continuously and passed continuously to an emulsifying apparatus, and prior to emulsification are mixed continuously with silanes (2), emulsifiers (4), and at least a portion of water as dispersion medium (3), and this mixture is supplied directly and continuously to a first high-shear mixer in which a viscous phase is formed, the pressure and the temperature being measured after this mixer and being regulated so as to form a very finely divided dispersion of constant composition and properties.

13. A dispersion of crosslinked organopolysiloxanes prepared by the process of claim 1.

14. A dispersion of crosslinked organopolysiloxanes prepared by the process of claim 3.

15. The dispersion of crosslinked organopolysiloxanes of claim 13, wherein water is used as a dispersion medium (3).

16. The dispersion of crosslinked organopolysiloxanes of claim 14, wherein the radical AKT is a radical of the formula —CH₂NHR⁵, —CH₂NR⁵₂ or 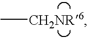
in which R⁵ is a monovalent C₁₋₁₈ hydrocarbon radical optionally containing N and/or O atoms, and R⁶ is a divalent C₃₋₁₂ hydrocarbon radical optionally containing N and/or O atoms.

17. A shaped body produced by removing the dispersion medium (3) from the dispersion of claim 13.

18. The shaped body of claim 17, wherein the dispersion medium (3) is water and wherein the dispersion is dried at a temperature of 5 to 150° C.

19. The shaped body of claim 17, which is a hard or elastomeric shaped body.

20. A method of producing a coating on a substrate or impregnating or infiltrating a substrate, comprising applying a dispersion of claim 13 to a substrate and removing the dispersion medium (3).
